(19) United States
(12) Patent Application Publication
(10) Pub. No.: US 2014/0035745 A1
(43) Pub. Date: Feb. 6, 2014

(54) MONITORING ONE OR MORE PARAMETERS

(71) Applicant: International Business Machines Corporation, Armonk, NY (US)

(72) Inventors: David R. Bell, Winchester (GB); Philip Norton, Winchester (GB)

(73) Assignee: International Business Machines Corporation, Armonk, NY (US)

(21) Appl. No.: 13/958,217

(22) Filed: Aug. 2, 2013

(30) Foreign Application Priority Data
Aug. 2, 2012 (GB) GB1213776.6

(51) Int. Cl. G08B 21/02

(52) U.S. Cl. CPC G08B 21/02
USPC 340/539.12; 340/573.1

(57) ABSTRACT

A method of monitoring an individual comprises measuring one or more parameters of the individual, accessing a list of pattern records, each pattern record defining a set of nodes relating to the measured parameter(s) and a specific end result for the set of nodes, matching the measured parameter(s) to a pattern record in the list, and generating a predefined output in relation to the specific end result of the matched pattern record.

### CROSS-REFERENCE TO RELATED APPLICATIONS

This application claims the benefit under 35 U.S.C. 119 of Patent Application No. GB1213776.6, filed Aug. 2, 2012, assigned to the assignee of the present application, and incorporated herein by reference.

### BACKGROUND

In many areas of life, there are requirements to gather medical data such as heart rate, blood pressure, respiration, perspiration, etc. from individuals in order to make assertions of their current health, and predictions on future outcomes. There are also many situations where it would be beneficial to gather such data, but where it is not commonly done due to a number of drawbacks. All of these areas would benefit from an easier way to gather data, and most importantly to process that data live and draw immediate predictions. These predictions might include that the user is currently having a heart attack or an asthma attack, or a stroke, or has been shot, has fallen unconscious, or perhaps is dehydrated, for example.

It is possible that the predictions are about future events, predicting that the user is now at high risk of a heart attack or other ailment in the future. Examples of those who would benefit from this live monitoring include patients in hospitals, out-patients at home, the elderly, young children, soldiers on the front and sportsmen and women, such as runners and other high-performance athletes such as cyclists and triathletes.

There are existing techniques for gathering data about a person's vital signs, including some which embed sensors into the person's clothing. For example, heart rate monitors using a watch and a chest strap are well-known, see www.polar.fi, for example. Such technology, however, does not perform any predictions on the user's future health and also requires the user to remember to put on the watch and the strap. Sensors in clothing are also known, see for example the article “Embedded Health Monitoring Sensors in Clothing”. This is a typical example of current so-called “smart clothing”. Such clothing contain sensors, but simply send the data onto a central server, as it is not possible to process the large amount of data locally. In this case, the data is actually provided to a doctor, for manual processing of the data. Again, no future health prediction is made. A second example of sensors in clothing is an article entitled “Under Armour—Smart garments include embedded sensors and on-board computer for biofeedback”. This is another example of embedded sensors, this time using Bluetooth to send the unprocessed data to a static central processing point.

These techniques normally require the data be transmitted elsewhere, or else stored locally, and later on downloaded to some other device for more processing. This is because existing techniques for the processing of the data, and drawing of conclusions or predictions is a processor intensive activity, requiring time and significant CPU power, and battery power. There are other disadvantages of existing solutions, such as remembering to take measurements, removing clothing to place sensors on the body, the stress of being examined and measured, temporarily having to put on sensors, such as the chest strap, remembering to take the transmitter/battery pack/local processing unit etc. and the time taken to perform these tasks, particularly for front line soldiers and high-performance athletes.

### BRIEF SUMMARY OF THE INVENTION

The preferred embodiment relates to a method and system for monitoring an individual. In a preferred embodiment, the invention can provide live prediction of an individual's medical condition from within their clothing.

According to a first aspect of the present invention, there is provided a method of monitoring an individual, the method comprising measuring one or more parameters of the individual, accessing a list of pattern records, each pattern record defining a set of nodes relating to the measured parameter(s) and a specific end result for the set of nodes, matching the measured parameter(s) to a pattern record in the list, and generating a predefined output in relation to the specific end result of the matched pattern record.

Owing to the invention, it is possible to provide a method whereby all of the required logic to monitor and most importantly to draw conclusions from the live data relating to user parameters can be embedded in clothing without the need for large power and processing capabilities. This is possible due to the use of pattern record technology, with its low processing power and energy requirements, meaning only a tiny unit would be needed to perform the predictions and power the system and thus could be embedded in the clothing along with the sensors that will measure the user parameters that provide indications of, for example, the user's health.

The system can monitor a wide range of statistics including vital statistics, orientation, perspiration and movement etc. and make predictions about the future values of these statistics, although it is not generating a diagnosis. It is possible to have extra manual assessment of the captured data, which then provides a logical conclusion as to what the prediction means, such as a heart rate prediction of zero means a heart attack is highly likely to take place, for example. A suitably qualified expert can annotate an end result to provide a useful interpretation of the underlying data of that node.

There are multiple key advantages of this methodology over existing art. Live prediction is provided so that the prediction is available immediately, without the time delay of either sending data off to a remote server which does a large amount of processing before sending it back, or worse waiting until some later date when the data has been processed. Local delivery of prediction is also provided as the resulting prediction of any medical condition is available to the user of the system (and possibly any surrounding people). No extra equipment is needed. By simply wearing suitable clothing such as a hospital gown, soldier baselayer top, athletes sports t-shirt, baby-grow etc. the user has a full working system. They cannot forget anything.

The system provides 24/7 monitoring as it is monitoring the user all of the time. This means the predictions are instant, and means that the system is useful in situations where regular monitoring sessions are no use such as emergency situations where heart attacks or being shot or going unconscious needs immediate identification. The system will work everywhere. There is no requirement for the user to stay in a bounded area, such as their house or a hospital or within range of some receiver. Solders and out-patients for example would be monitored wherever they went. No examination of the user is required. There is no need to remember to be measured, there is no need to find a medical person to perform it and there is no need to spend the time being examined. Soldiers on the front line cannot afford to stop and be examined. The elderly and children could be easily stressed, or put off examination.

### BRIEF DESCRIPTION OF THE DRAWINGS

Preferred embodiments of the present invention will now be described, by way of example only, with reference to the following drawings, in which:

FIG. 1 is a schematic diagram of a set of pattern records,

FIG. 2 is a flow diagram of method of creating and using pattern keys,

FIG. 3 is a schematic diagram of the creation of a pattern key from data from multiple individuals,

FIG. 4 is a schematic diagram of an individual using a system for monitoring their health,

FIG. 5 is a schematic diagram of a control unit of the system of FIG. 4, and

FIG. 6 is a flow diagram of a method of operating the system of FIG. 4.

### DETAILED DESCRIPTION OF THE DRAWINGS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks or registered trademarks of Oracle and/or its affiliates), Smalltalk, C++ or the like and conventional procedural programming languages, such as the “C” programming language or similar programming languages. The program code may execute entirely on the user's computer, partly on the users computer, as a stand-alone software package, partly on the users computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

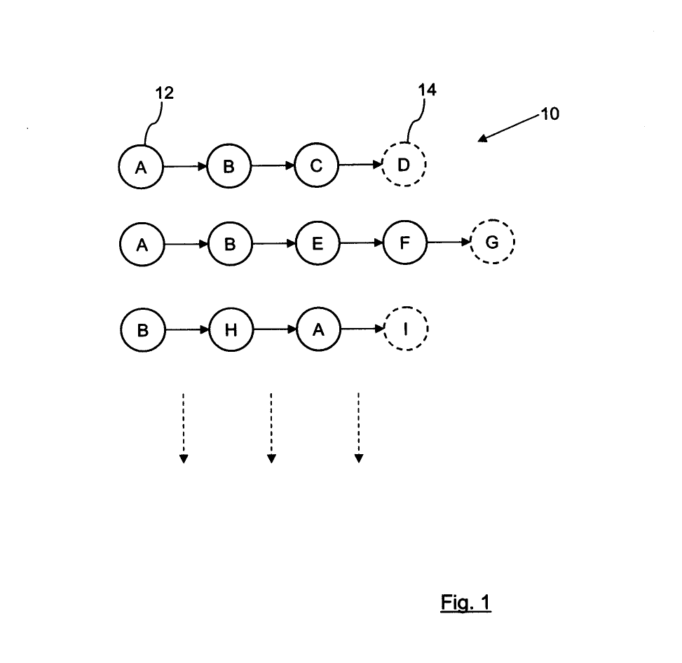

FIG. 1 shows a list of pattern records 10. Each pattern record 10 defines a set of nodes 12 and also a specific end result 14 for the set of nodes 12. The first pattern record 10 defines the sequence of nodes A→B→C which lead to the end result of D. Each pattern record 10 defines an end result 14 that is likely to occur with a high probability given the set of nodes 12. There are two types of pattern records 10, being pattern keys and pattern collections. A pattern key describes a sequence of nodes that are ordered and a pattern collection describes a collection of nodes that are unordered.

The pattern records 10 of FIG. 1 are in fact all pattern keys, in that the nodes 12 are ordered. The arrows between nodes 12 indicate that they form a sequence of nodes 12. These nodes 12 represent data relating to user parameters. In the simplest embodiment, only a single parameter will be represented, such as an individual's heart rate. The nodes A, B and C can represent specific information relating to this specific parameter. This information could be in the form of a single value or could be represented as a more complex condition such a percentage change or specific absolute increase in the value of the measured heart rate.

For example, node A might represent a heart rate of 130 bpm and node B might represent a heart rate of 150 bpm and node C might represent a heart rate below 130 bpm. Node D could therefore indicate that the individual's heart rate will fall below 50. This pattern key 10 would indicate that should nodes A, B and C occur in that order for a specific individual, then there is a high likelihood of the outcome D occurring. This provides a prediction, based on probability, about the individual's health, but it is not a diagnosis.

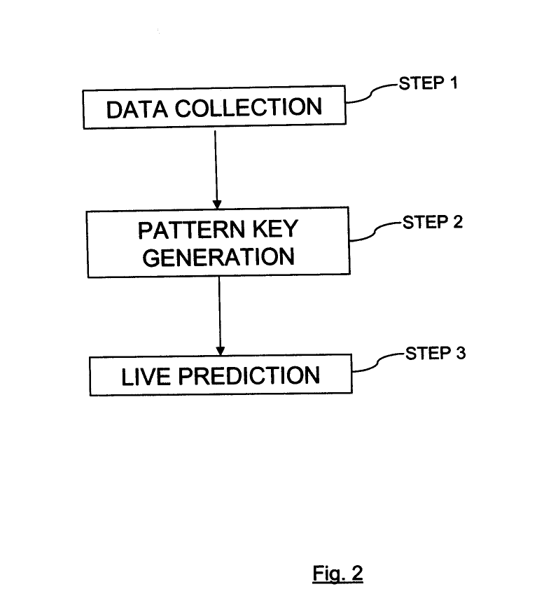

The use of pattern keys has three phases, data collection, pattern key generation and live prediction, as illustrated in FIG. 2. The methodology discussed here is applicable to pattern records in general, i.e. it also covers pattern collections. In data collection step (step 1), data from various sensors embedded in the clothing of one (or more) individuals would be captured and stored over a period of time. This would include things such as, but not limited to, heart rate, blood pressure, respiration, perspiration, movement, location, orientation. Each of these data points would be stored as a node in a larger neural net, with the individual's data making a path between certain nodes.

In step 2, the pattern key generation step, once a large amount of data has been captured for that individual, the neural net of data would be processed (using known techniques) to produce pattern keys. This process involves looking at the number of times various nodes being matched resulted in certain result, and applying a threshold such that all cases where the matching of a set of nodes gave a higher than X probability of the end result occurring, were extracted and saved as a pattern key. X might be 85%, for example. These keys would contain a number of nodes and a destination node, where it can be accurately predicted that if the nodes are all visited by the user, it can be accurately predicted that the end event will occur. It would also be possible to generate and use pattern collections, rather than pattern keys, as discussed above. Pattern collections are an unordered collection of nodes that must be matched before the prediction is made.

The pattern records so generated can be used as they are, without any human input. However, it is also possible that human interpretation can be placed on the predicted node (the end result). For instance, in the example above where the user's heart rate is expected to fall below 50 BPM, this could be labelled as a heart attack by a suitable medical professional, who can review the patent records that have been generated. This labelling can be alternatively, or in addition to the actual parameter measurement captured in the final node 14.

In step 3, live prediction, the pattern keys can then be loaded into the system for the users to wear. The system then monitors all of the sensors (the same sensors that were used to capture data in the data collection step), looking for the conditions of a pattern key to be met. When all of the conditions of a pattern key are met the prediction of the end event is made, such as the user is suffering a heart attack, or has been shot, or fallen unconscious. This prediction could then be used for a wide range of things, though what an implementer chooses to do with the prediction is highly dependent on the reason for monitoring the individual. Outputs can be provided such as audible alerts, lights, or transmission of an alert to nearby personnel. Inaudible alerts such as the use of a vibration output can also be provided.

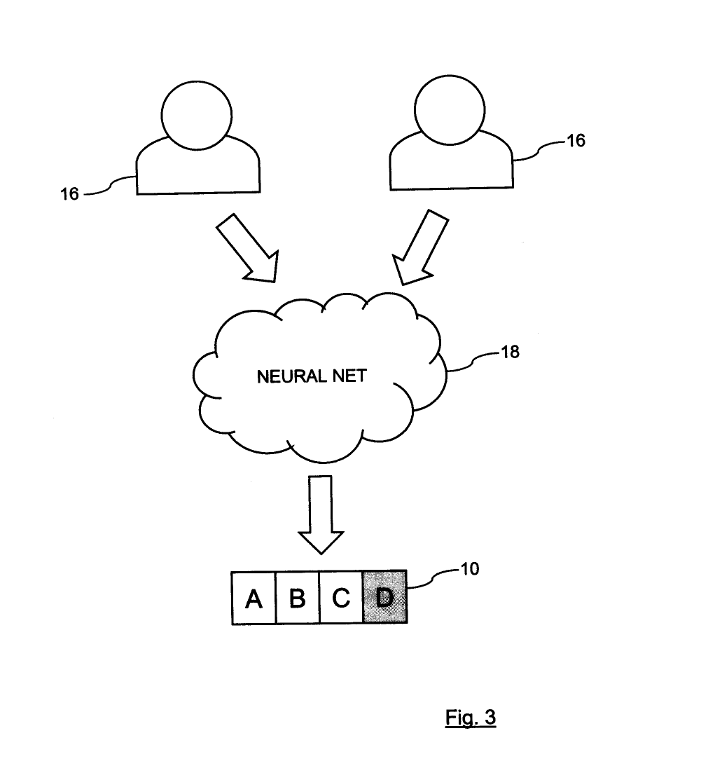

The creation of the pattern keys and pattern collections can involve the capture and processing of data from multiple individuals. This is illustrated in FIG. 3, which shows multiple individuals 16 who have one or more of their parameters measured. All of the tracked users' data are recorded and stored as nodes in a neural net 18. A path is drawn between all of the nodes showing the order the user performed them in, if the system is generating pattern keys. If pattern collections are used, the nodes are simply grouped together. This continues until sufficient data has been captured to highlight the patterns of many individuals, to allow accurate predictions to be made.

For the pattern key generation, the neural net 18 of nodes captured from the multiple users 16 over a long period of time, is processed to identify paths through the nodes which have a high probability of going to a certain destination. A pattern key 10 is created containing the smallest subset of nodes that if the user matches each node in the pattern key 10, it can be accurately predicted that the end event will occur. The process is repeated until all the required pattern keys 10 have been produced. This can be achieved by generating all of the pattern keys where the probability of prediction is above a value X.

In relation to capturing data from multiple users, as described above, when selecting the smallest subset of relevant decision points, in some cases the decision point representing the identification of the user will be removed, and sometimes it will be kept. This means that where the prediction is only accurate for a particular individual, a pattern key or collection will be generated including the node representing individuals identity, thus it can only ever match all nodes and make a prediction for that user. However, where the prediction is accurate for all users, the user identity will be removed as part of the process, and the pattern record will match for any user.

A users live sensor data is compared against the nodes in each pattern key being used. If the user's data matches the first node in a particular pattern key, the user's subsequent data is then compared against the second node for that particular pattern key. (If pattern collections are used, the node is simply ticked off, and monitoring of the remaining nodes in the pattern collection continues). All pattern keys continue to be monitored. If all the nodes of a particular pattern key are matched, a prediction can be made that the user will experience the end result associated with the destination node for that particular pattern key. The appropriate action can then be taken.

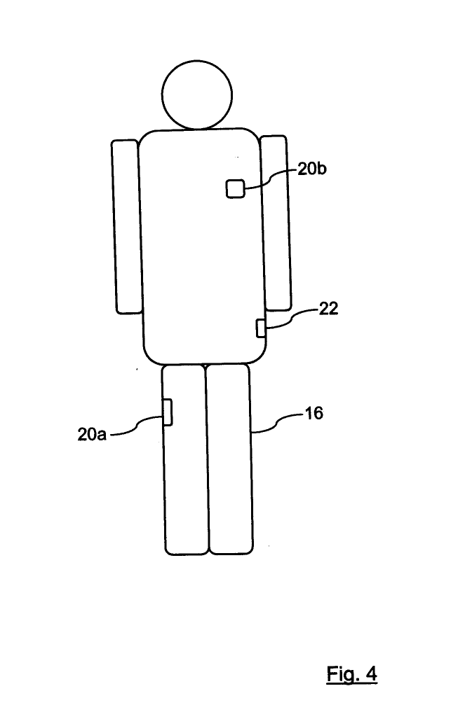

FIG. 4 shows an example of an individual 16 who is fitted with a system for monitoring their parameters. The system comprises two sensors 20 and a control unit 22. The sensor 20a is an accelerometer based unit that is measuring the movement and orientation of the individual 16. The sensor 20b is a heart rate monitor that is measuring the individual's heart rate in beats per minute. The control unit 22 contains processing, storage and wireless communication capabilities and is in wireless communication with the two sensors 20. The two sensors 20 and the control unit 22 are all embedded in the individual's clothing and do not require any configuration or input from the individual 16. The control unit 22 could also be connected to the sensors 20 using a wired system, with wires embedded in the seams of clothing.

The individual 16 could be a soldier who is deployed in a combat situation. The system provided by the sensors 20 and control unit 22 is monitoring the health of the individual 16 without any need for the individual 16 to take any action with respect to the system. The control unit 22 stores a large number of pattern records 10, whether they are pattern keys or pattern collections or a combination of the two. These pattern records 10 may have been generated specifically for the individual 16 being monitored or may be global pattern records 10 that are not specific to any one individual. Both specific and global pattern records 10 could be stored in the control unit 22.

The principal advantage of the system of FIG. 4 is that the power and processing requirements of the control unit 22 are very low compared to a device that would need to process the received data from the sensors 20. The control unit 22 does not process the received data from the sensors 20 in any way; the control unit 22 simply matches any received data point with nodes stored in the pattern records 10. This is a real-time and continuous process, as the control unit 22 tries to match the received data with a stored pattern record 10. Once a match has been made, then a predefined output is generated in relation to the pattern record 10 that has been matched.

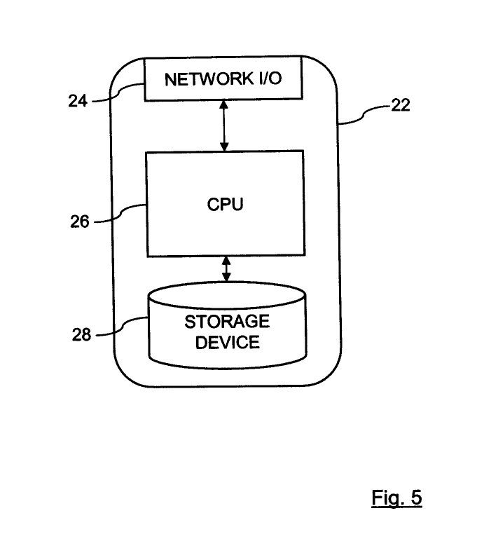

FIG. 5 shows more detail of the control unit 22 that is carried by the individual 16, as shown in FIG. 4. The control unit 22 comprises a wireless network interface 24, a processing device 26 and a storage device 28. The control unit 22 will also have a small in-built battery (not shown) to power the various components of the control unit 22. The wireless interface 24 communicates with the sensors 20 and also has the capability to communicate with a remote device. If the control unit 22 is connected to the sensors 20 via a wired connection, then a suitable connection interface will be provided. The storage device 28 stores the pattern records 10 that have been pre-loaded onto the storage device 28, which is essentially a list of the pattern records 10. The pattern records 10 are stored directly in memory or in a simple file, using XML or JSON for example.

The primary functions of the control unit 22 are to provide matching between the incoming data from the sensors 20 and the stored pattern records 10 and to control the operation of the network interface 24. The sensors 20 can be configured to take period snapshots of the individual's parameters that they measure and provide them to the control unit 22. For example, the heart rate monitor 20b could be configured to measure the individual's heart rate every second and provide the measurement every second to the control unit 22. The accelerometer 20a could capture movement speed and orientation data every five seconds and provide this to the control unit 22.

Each pattern record 10 that the storage device 28 stores will have multiple nodes 12 and the processing device 26 is taking the incoming measurements from the sensors 20 and matching them to the nodes 12 of the pattern records 10, which are essentially stored in a giant look-up table with the storage device 28. At any one time a large number of pattern records 10 are potential matches as the data comes in from the sensors 20, but a full match is made only when all of the nodes 12 in a pattern record are matches to the incoming data. In the case of a stored pattern key 10, then the nodes have to be matched in sequence for there to be a correct result.

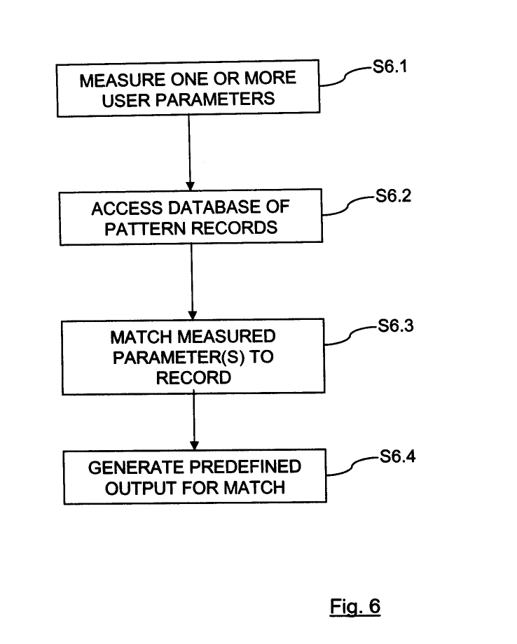

FIG. 6 summarises the method of monitoring the individual, which is the operation of the sensors 20 and the control unit 22. The method comprises firstly, step S6.1, measuring one or more parameters of the individual 16, secondly, step S6.2, accessing the list of pattern records 10, each pattern record 10 defining a set of nodes 12 relating to the measured parameter(s) and a specific end result 14 for the set of nodes 12, thirdly step S6.3, matching the measured parameter(s) to a pattern record 10 in the list, and finally, step S6.4, generating a predefined output in relation to the specific end result 14 of the matched pattern record 10.

The step S6.4 of generating a predefined output in relation to the specific end result 14 of the matched pattern record 10 may comprise outputting a warning to the individual 16. For example, if the user's heart rate is matched to a pattern record 10 which indicates that there is a high likelihood of the individual 16 suffering a heart attack, then an immediate audible warning to the individual 16 can be provided. Inaudible warnings using vibration can also be used to alert the individual 16. Additionally, or alternatively, the step of generating a predefined output in relation to the specific end result 14 of the matched pattern record 10 can comprise transmitting a message over a wireless network to a remote device, the message comprising content indicative of the specific end result. Here a warning could be transmitted, for example to a medical centre, which indicates that the individual 16 is in need of urgent attention.

The measuring of the parameters of the individual 16 can comprise measuring multiple parameters of the individual 16, such as heart rate and perspiration, for example and therefore pattern records 10 in the list of pattern records 10 can comprise nodes 12 that relate to different measured parameters. This means that a single pattern record 10 will have individual nodes 12 that relate to different parameters or indeed a single node 12 within a pattern record 10 could combine information about two different user parameters. The processing device 26 of the control unit 22 is neutral as regards the contents of the pattern records 10 as the matching is performed in relation to the incoming data with the stored pattern records 10.

1. A method of monitoring an individual, the method comprising:
measuring one or more parameters of the individual,
accessing a list of pattern records, each pattern record defining a set of nodes relating to the measured parameter(s) and a specific end result for the set of nodes,
matching the measured parameter(s) to a pattern record in the list, and
generating a predefined output in relation to the specific end result of the matched pattern record.

2. A method according to claim 1, wherein the step of generating a predefined output in relation to the specific end result of the matched pattern record comprises outputting a warning to the individual.

3. A method according to claim 1, wherein the step of generating a predefined output in relation to the specific end result of the matched pattern record comprises transmitting a message over a wireless network to a remote device, the message comprising content indicative of the specific end result.

4. A method according to claim 1, wherein the step of measuring one or more parameters of the individual comprises measuring multiple parameters of the individual and wherein one or more pattern records in the list of pattern records comprise nodes that relate to different measured parameters.

5. A system for monitoring an individual, the system comprising:
one or more sensors arranged to measure one or more parameters of the individual,
a storage device arranged to store a list of pattern records, each pattern record defining a set of nodes relating to the measured parameter(s) and a specific end result for the set of nodes, and
a processing device connected to the or each sensor and to the storage device and arranged to access the list of pattern records, match the measured parameter(s) to a pattern record in the list, and generate a predefined output in relation to the specific end result of the matched pattern record.

6. A system according to claim 5, wherein the processing device is arranged, when generating a predefined output in relation to the specific end result of the matched pattern record, to output a warning to the individual.

7. A system according to claim 5, wherein the processing device is arranged, when generating a predefined output in relation to the specific end result of the matched pattern record, to transmit a message over a wireless network to a remote device, the message comprising content indicative of the specific end result.

8. A system according to claim 5, wherein the one or more sensors are arranged to measure multiple parameters of the individual and wherein one or more pattern records in the list of pattern records comprise nodes that relate to different measured parameters.

9. A computer program product on a computer readable medium for monitoring an individual, the product comprising instructions for:
measuring one or more parameters of the individual,
accessing a list of pattern records, each pattern record defining a set of nodes relating to the measured parameter(s) and a specific end result for the set of nodes,
matching the measured parameter(s) to a pattern record in the list, and
generating a predefined output in relation to the specific end result of the matched pattern record.

10. A computer program product according to claim 9, wherein the instructions for generating a predefined output in relation to the specific end result of the matched pattern record comprise instructions for outputting a warning to the individual.

11. A computer program product according to claim 9, wherein the instructions for generating a predefined output in relation to the specific end result of the matched pattern record comprise instructions for transmitting a message over a wireless network to a remote device, the message comprising content indicative of the specific end result.

12. A computer program product according to claim 9, wherein the instructions for measuring one or more parameters of the individual comprise instructions for measuring multiple parameters of the individual and wherein one or more pattern records in the list of pattern records comprise nodes that relate to different measured parameters.
